(19) United States
(12) Patent Application Publication
(10) Pub. No.: US 2014/0125638 A1
(43) Pub. Date: May 8, 2014

(54) ELECTROMAGNETIC POINTER

(71) Applicant: WALTOP INTERNATIONAL CORPORATION, Hsinchu City (TW)

(72) Inventor: CHIH-JEN LI, Hsinchu City (TW)

(73) Assignee: WALTOP INTERNATIONAL CORPORATION, Hsinchu City (TW)

(21) Appl. No.: 13/853,442

(22) Filed: Mar. 29, 2013

(30) Foreign Application Priority Data
Nov. 6, 2012 (TW) 101221467

(51) Int. Cl. G06F 3/0354

(52) U.S. Cl. CPC G06F 3/03545
USPC 345/179

(57) ABSTRACT

An electromagnetic pointer is disclosed. The electromagnetic pointer includes at least one pen tube assembly, a pen tip, a core holder configured in the pen tube assembly with a surrounding coil, a ferrite core, an elastomer, a touch pin configured in the core holder and the pen tube assembly and a circuit board.

### CROSS-REFERENCE TO RELATED APPLICATIONS

The entire contents of Taiwan Patent Application No. 101221467, filed on Nov. 6, 2012, from which this application claims priority, are incorporated herein by reference.

### FIELD OF THE INVENTION

The present invention generally relates to an electromagnetic pointer, more particularly to an electromagnetic pointer with a variable inductor.

### BACKGROUND OF THE INVENTION

Input apparatuses such as smart mobile devices (smart phones), digitizers or tablets or e-books/green books usually are used with electromagnetic pointers or styluses so as to perform input function.

An input apparatus includes a plurality of antennas or sensor coils forming a sensing plane arranged under a work surface or a screen of the input apparatus. During the operation of an electromagnetic pointer, the coordinates of the electromagnetic pointer are obtained through the transmitting and receiving of electromagnetic waves between the circuit of the electromagnetic pointer and the antennas or the sensor coils of the input apparatus.

The circuit of an electromagnetic pointer usually comprises an inductor, a capacitor and relative components enclosed in a case. The inductor constituted by a ferrite core winded with a metal coil and the capacitor constitute the circuit to transmit and receive electromagnetic waves with the antennas or sensor coils, The frequency variation of the circuit is achieved via changing the capacitance and/or the inductance so that the design of the pointer can choose either the inductor or capacitor to be variable or adjustable according to the requirement.

The invention provides an electromagnetic pointer with a variable inductor.

### SUMMARY OF THE INVENTION

One object of the invention is to provide an electromagnetic pointer with a variable inductor which utilizes a contact force applied upon to alter the contact status between the conductive terminals of the circuit board and the conductive device to initiate the function of the electromagnetic pointer when an electromagnetic pointer is in use.

The invention provides an electromagnetic pointer comprising at least one pen case, a pen tip, a core holder and a coil winding the core holder, a ferrite core, an elastomer, a touch pin and a circuit board. The pen tip is configured to be located in the pen case and extending out from the pen case. The core holder and the coil winding the core holder are configured to be located in the pen case. The ferrite core is configured to be located in the core holder and the pen case and contacts the pen tip. The elastomer and the touch pin are configured to be located in the core holder and the pen case. The elastomer is between the ferrite core and the touch pin. One end of the touch pin extends out from the core holder. The circuit board has a plurality of conductive terminals on one end thereof. The conductive terminals are adjacent the touch pin. A conductive device is between the conductive terminals and the touch pin, and the coil connects to the circuit board.

### BRIEF DESCRIPTION OF THE DRAWINGS

FIG. 1 shows an electromagnetic pointer according to one embodiment of the present invention.

FIG. 1A shows a cross-sectional view of an electromagnetic pointer according to one embodiment of the present invention.

### DETAILED DESCRIPTION OF THE INVENTION

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments, On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations are not described in detail in order not to unnecessarily obscure the present invention.

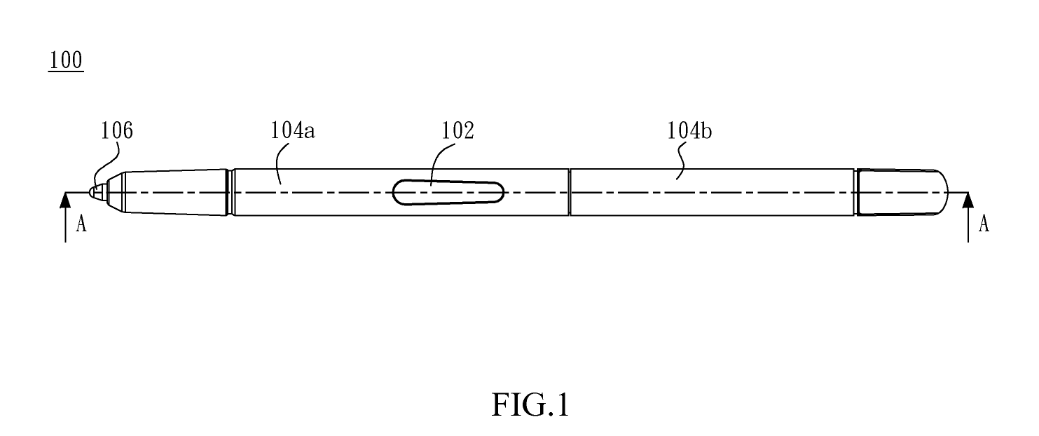

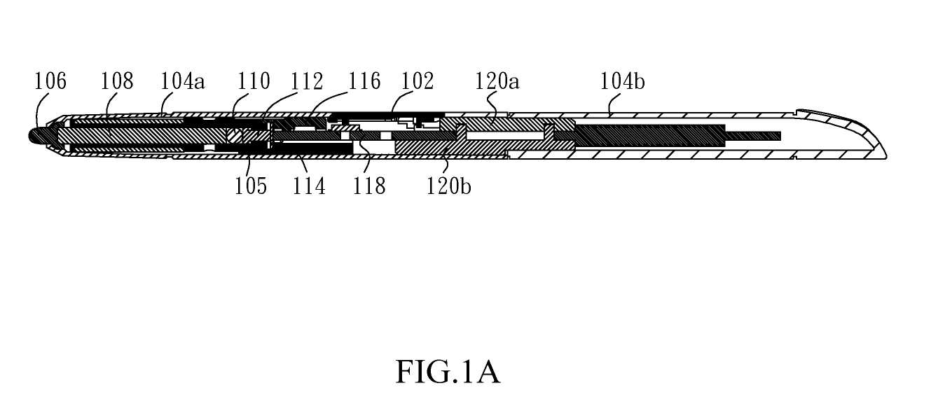

FIG. 1 shows an electromagnetic pointer according to one embodiment of the present invention. FIG. 1A shows a cross-sectional view of an electromagnetic pointer according to one embodiment of the present invention. As shown in FIG. 1, the electromagnetic pointer 100 comprises a switch 102, pen cases 104a and 104b (first and second pen cases), and a pen tip 106.

In the embodiment shown in FIG. 1A, the electromagnetic pointer 100 further comprises a circuit board 118, a core holder 105, a holder 106, holders 120a and 120b, an elastomer 110, a touch pin 112, a ferrite core 108 and a conductor device 114. The pen cases 104a and 104b comprise hollow pen shell components made of non-metal materials to accommodate the circuit board 118, the core holder 105, the holder 106, the holders 120a and 120b, the elastomer 110, the touch pin 112, the ferrite core 108. The diameters of the pen cases 104a and 104b can be smaller than about 6 mm, and is preferably about 5.5 mm, but is not limited to 5.5 mm. The diameters of the pen cases 104a and 104b can also be larger than about 6 mm.

In one embodiment of the invention, the circuit board 118 comprises a printed circuit board with a LC circuit and a controller so that the electromagnetic pointer is able to transmit electromagnetic signals to an electromagnetic input apparatus, or to receive electromagnetic signals from electromagnetic antenna loops or sensor coils of the electromagnetic input apparatus. The electromagnetic input apparatus comprises a smart mobile communication device, digitizer or tablet or eBook.

In one embodiment of the invention, the pen tip 106 penetrates through the pen case 104a and extends from one opening of one end of the pen case 104a. The pen tip 106 comprises one contact end used for contacting the contact surface of the input apparatus and a second end with a larger cross sectional area comparing to that of the contact end. The cross sectional area of the second end is larger than the inner diameter of the end of the pen case 104a toward the pen tip so that the pen tip 106 will not completely penetrate through the pen case 104a and will be limited inside the pen case 104a.

In one embodiment of the invention, the ferrite core 108 is configured to be located in the hollow pen case 104a and to be arranged after the pen tip 106. The hollow core holder 105 is configured to be located in the hollow pen case 104a. The hollow core holder 105 is used to secure the ferrite core 108 so that the ferrite core 108 is able to be moved axially inside the pen case 104a. The elastomer 110 and the touch pin 112 are configured to be located in the core holder 105, and the elastomer 110 is located between the ferrite core 108 and the touch pin 112. The inner diameter of the end of the core holder 105 toward the pen tip is larger than that of the other end of the core holder 105. The diameter or cross-sectional area of the end of the touch pin 112 toward the pen tip is larger than that of the other end of the touch pin 112. The diameter or cross-sectional area of the other end of the touch pin 112 is larger than the inner diameter of the other end of the core holder 105 so that the touch pin 112 can be limited in the core holder 105 after the touch pin 112 is partially through the core holder 105,

In one embodiment of the invention, the circuit board 118 is configured to be secured in the pen cases 104a and 104b via the holder 116, the core holder 105, the holder 120a and 120b. The end of the circuit board 118 toward the pen tip of the electromagnetic pointer has a plurality of conductive terminals. The conductive device 114 is configured to be located between the circuit board 118 and the touch pin 112. The conductive terminals of the circuit board 118 are electrically connected through the conductive device 114 after the touch pin 112 pushes the conductive device 114. Detailed content will be further described in the following description. The switch 102 is configured to be located on the circuit board 118 and extend out from the pen case 104a. The switch 102 is used as a switch of the circuit board 118.

The pen tip 106 penetrates through the pen case 104a so that the pen tip 106 is able to slide inside the pen case 104a. The ferrite core 108 is configured to be located in the hollow pen case 104a and to be arranged after the pen tip 106. The elastomer 110 and the touch pin 112 are configured to be located after the ferrite core 108 and inside the core holder 105. The elastomer 110 is configured to be located between the ferrite core 108 and the touch pin 112, The touch pin 112 is configured to be able to be moved and limited inside the core holder 105. When the core holder 105, the holder 116, the switch 102, the holders 120a and 120b and the circuit board 118 are configured to be secured in the pen cases 104a and 104b, the pen tip 106, the ferrite core 108, the elastomer 110 and the touch pin 112 are configured to be restricted inside the space constituted by the pen case 104a and the core holder 105.

In one embodiment of the invention, since the space constituted by the pen case 104a and the core holder 105 is constant, the moving distance of the pen tip 106, the ferrite core 108 and the touch pin 112 is directly related to the compressibility of the elastomer 110.

In one embodiment of the invention, the conductive device 114 is configured to be located in the holder 116 and the core holder 105 and between the conductive terminals of the circuit board 118 and the end of the touch pin 112 extending out from the core holder 105. The conductive device 114 alters the status of contact with the conductive terminals of the circuit board 118 via the pushing of the end of the touch pin 112 extending out from the core holder 105 so as to connect the conductive terminals of the circuit board 118 and change the electric properties of the circuit board 118 such as LC oscillation frequency.

In one embodiment of the invention, the conductive device 114 comprises a cone spring or a conductive rubber, but is not limited to a cone spring or a conductive rubber. In one embodiment which the conductive device 114 is a cone spring, when one end of the touch pin 112 pushes the cone spring, the center of the cone spring will contact the conductive terminals on one end of the circuit board 118 to electrically connect the conductive terminals and the change the electric properties of the circuit board 118 such as LC oscillation frequency. The electrical connection between the conductive terminals is able to be used to initiate the writing function of an electromagnetic pointer, but is not limited to initiate the writing function.

In one embodiment of the invention, a conductive coil is configured to wind the core holder 105; the conductive coil is configured to be connected to the circuit of the circuit board 118. The conductive coil and the ferrite core 108 constitute a variable inductor. The variable inductor is configured to be connected to the LC circuit of the circuit board 118. The inductance of the variable inductor or the frequency of the LC circuit is changed through the relative displacement between the ferrite core 108 and the conductive coil generated by the axial movement of the ferrite core 108 inside the core holder 105 with the winding conductive coil to create an induced current. The variation of the frequency is able to be used to change the line width of the trace of an electromagnetic pointer, but is not limited to the line width of the trace.

In one embodiment of the invention, the switch 102 is configured to partially penetrate through the opening of the pen case 104a and to be located on the circuit board 118 as a switch of a circuit function thereof. The switch 102 is configured to be used as the switch of writing or erasing functions of the electromagnetic pointer, but is not limited to writing or erasing functions.

It is noted that the embodiments of the invention focus on the configuration of the electromagnetic pointer rather than the function thereof. Thus the configuration of the embodiments of the invention is able to be applied any function of the electromagnetic pointer according to various requirements. The function which the configuration of the embodiments of the invention is applied to perform depends on circuit design.

In one embodiment of the invention, the elastomer 110 comprises, but is not limited to, rubber or other elastic material. When an electromagnetic pointer is in use, a contact force is applied upon one end of the pen tip 106 and is transferred to the other end of the pen tip 106 and the ferrite core 108. The ferrite core 108 compresses the elastomer 110 and pushes the touch pin 112. The touch pin 112 pushes the conductive device 114 to alter the contact status between the conductive terminals of the circuit board 118 and the conductive device 114 to initiate the function of the electromagnetic pointer such as the writing function. When the electromagnetic pointer is not in use, there is a gap between the touch pin 112 and the conductive device 114.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims,

What is claimed is:

1. An electromagnetic pointer, comprising:
at least one pen case;
a pen tip being configured to be located in the pen case and extending out from the pen case:
a core holder and a coil winding the core holder being configured to be located in the pen case;
a ferrite core being configured to be located in the core holder and the pen case and contacting the pen tip;
an elastomer and a touch pin being configured to be located in the core holder and the pen case, the elastomer being between the ferrite core and the touch pin, one end of the touch pin extending out from the core holder; and
a circuit board with a plurality of conductive terminals on one end thereof, the conductive terminals adjacent the touch pin, a conductive device being between the conductive terminals and the touch pin, and the coil connecting to the circuit board.

2. The electromagnetic pointer of claim 1, wherein the conductive device comprises a cone spring.

3. The electromagnetic pointer of claim 1, wherein the electromagnetic pointer is used with a smart mobile communication device, a digitizer or an eBook.

4. The electromagnetic pointer of claim 1, wherein the elastomer comprises rubber.

5. The electromagnetic pointer of claim 1 further comprising a switch, the switch being configured to partially penetrate through an opening of the pen case and to be located on the circuit board for switching a circuit function of the circuit board.

6. The electromagnetic pointer of claim 5, wherein the switch is configured to be used as the switch of writing or erasing functions.

7. An electromagnetic pointer used with an electromagnetic input apparatus, comprising:
a first pen case and a second pen case;
a pen tip being configured to be located in the first pen case and extending out from the first pen case;
a core holder and a coil winding the core holder being configured to be located in the first pen case;
a ferrite core being configured to be located in the core holder and the first pen case and contacting the pen tip;
an elastomer and a touch pin being configured to be located in the core holder and the first pen case, the elastomer being between the ferrite core and the touch pin, one end of the touch pin extending out from the core holder; and
a circuit board with a plurality of conductive terminals on one end thereof, the conductive terminals adjacent the touch pin, a conductive device being between the conductive terminals and the touch pin, and the coil connecting to the circuit board, the first case and the second case being combined to include the circuit board.

8. The electromagnetic pointer of claim 7 further comprising a switch, the switch being configured to partially penetrate through an opening of the first pen case and to be located on the circuit board for switching a circuit function of the circuit board.

9. The electromagnetic pointer of claim 8, wherein the switch is configured to be used as the switch of writing or erasing functions.

10. The electromagnetic pointer of claim 7, wherein the conductive device comprises a cone spring.

11. The electromagnetic pointer of claim 7, wherein the elastomer comprises rubber.

12. The electromagnetic pointer of claim 7, wherein the diameters of the first case and the second case are about 5.5 mm.

13. The electromagnetic pointer of claim 7, wherein the electromagnetic input apparatus comprises a smart mobile communication device, a digitizer or an eBook.
